(19) United States
(12) Patent Application Publication
(10) Pub. No.: US 2026/0104587 A1
(43) Pub. Date: Apr. 16, 2026

(54) HEAD-UP DISPLAY

(71) Applicant: Japan Display Inc., Tokyo (JP)

(72) Inventor: Takeo KOITO, Tokyo (JP)

(21) Appl. No.: 19/347,334

(22) Filed: Oct. 1, 2025

(30) Foreign Application Priority Data
Oct. 10, 2024 (JP) 2024-177953

(51) Int. Cl. G02B 27/01; G02B 30/31

(52) U.S. Cl. CPC G02B 27/0101; G02B 30/31; G02B 2027/0134

(57) ABSTRACT

According to an aspect, a head-up display includes: a liquid crystal display device configured to emit first light corresponding to a first image from a display surface toward a light-transmitting body in a first emission direction and to emit second light corresponding to a second image from the display surface in a second emission direction different from the first emission direction; and a reflective plate having a reflection surface on which the second light is incident and that reflects the second light toward the light-transmitting body in the first emission direction.

### CROSS-REFERENCE TO RELATED APPLICATION

This application claims the benefit of priority from Japanese Patent Application No. 2024-177953 filed on October 10, 2024, the entire contents of which are incorporated herein by reference.

### BACKGROUND

### 1. Technical Field

What is disclosed herein relates to a head-up display.

### 2. Description of the Related Art

As an example of a head-up display, Japanese Patent Application Laid-open Publication No. 2004-168230 (JP-A-2004-168230) discloses a vehicle-mounted display device configured to project a plurality of virtual images at positions different from each other. Japanese Patent Application Laid-open Publication No. 2016-137746 (JP-A-2016-137746) discloses a head-up display device configured to project two virtual images at tilt degrees different from each other.

The head-up display of JP-A-2004-168230 includes a plurality of display plates (liquid crystal display devices) in order to display a plurality of virtual images. The head-up display of JP-A-2016-137746 includes two display surfaces with tilt degrees different from each other in order to display two virtual images. Thus, the head-up displays of JP-A-2004-168230 and JP-A-2016-137746 include a plurality of display surfaces in order to project a plurality of virtual images, and accordingly, are relatively large-sized.

For the foregoing reasons, there is a need for downsizing of a head-up display capable of projecting two virtual images with tilt degrees different from each other.

### SUMMARY

According to an aspect, a head-up display includes: a liquid crystal display device configured to emit first light corresponding to a first image from a display surface toward a light-transmitting body in a first emission direction and to emit second light corresponding to a second image from the display surface in a second emission direction different from the first emission direction; and a reflective plate having a reflection surface on which the second light is incident and that reflects the second light toward the light-transmitting body in the first emission direction.

According to an aspect, a head-up display includes: a liquid crystal display device configured to emit first light corresponding to a first image from a display surface toward a light-transmitting body in a first emission direction and to emit second light corresponding to a second image from the display surface in a second emission direction different from the first emission direction; a 1/4 wave plate on which the second light emitted from the display surface is incident; and a reflective plate having a reflection surface that reflects light transmitted through the 1/4 wave plate, in the second emission direction toward the display surface through the 1/4 wave plate. A first angle between a direction orthogonal to the display surface and the first emission direction is equal to a second angle between the orthogonal direction and the second emission direction. The liquid crystal display device includes a reflective polarizing plate configured to pass linearly polarized light having a first polarization direction and to reflect linearly polarized light having a second polarization direction orthogonal to the first polarization direction.

### BRIEF DESCRIPTION OF THE DRAWINGS

FIG. 1 is a schematic diagram of a head-up display according to a first embodiment of the present disclosure;

FIG. 2 is a conceptual diagram of a liquid crystal display device illustrated in FIG. 1;

FIG. 3 is a plan view of the liquid crystal display device illustrated in FIG. 1;

FIG. 4 is a side view of the liquid crystal display device illustrated in FIG. 3;

FIG. 5 is a diagram illustrating an arrangement of first and second sub pixels illustrated in FIG. 3;

FIG. 6 is a diagram illustrating a circuit configuration of a display panel illustrated in FIG. 3;

FIG. 7 is a sectional view of the display panel illustrated in FIG. 3;

FIG. 8 is a plan view of a parallax barrier illustrated in FIG. 7;

FIG. 9 is a diagram illustrating a first virtual image and a second virtual image visually recognized by a viewer, in the head-up display illustrated in FIG. 1;

FIG. 10 is a schematic diagram of the head-up display according to a second embodiment of the present disclosure;

FIG. 11 is a schematic diagram of the head-up display according to a third embodiment of the present disclosure;

FIG. 12 is a sectional view of the display panel included in the liquid crystal display device illustrated in FIG. 11;

FIG. 13 is a diagram of a 1/4 wave plate illustrated in FIG. 11 when viewed in a direction orthogonal to a reflection surface;

FIG. 14 is a diagram illustrating the first virtual image and the second virtual image visually recognized by the viewer in the head-up display illustrated in FIG. 11;

FIG. 15 is a diagram illustrating an arrangement of first and second sub pixels in the liquid crystal display device included in the head-up display according to a modification of the embodiments of the present disclosure; and

FIG. 16 is a plan view of the parallax barrier in the liquid crystal display device included in the head-up display according to the modification of the embodiments of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

X, Y, and Z directions illustrated in the drawings correspond to the depth, width, and height directions of a head-up display 1. The X, Y, and Z directions are orthogonal to each other. The X, Y, and Z directions are exemplary, and the present disclosure is not limited to these directions.

### First Embodiment

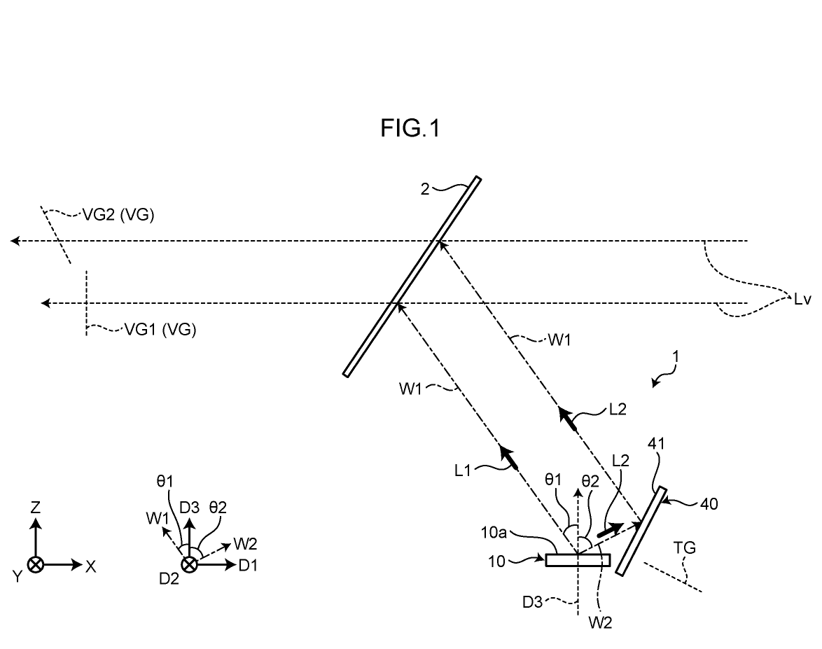

FIG. 1 is a schematic diagram of the head-up display 1 according to a first embodiment of the present disclosure. The head-up display 1 (hereinafter also referred to as a HUD 1) projects an image onto a light-transmitting body 2 to allow visual recognition of a virtual image VG by a viewer. The light-transmitting body 2 is plate-shaped and has a light-transmitting property. The light-transmitting body 2 is, for example, a windshield or a combiner of a vehicle but not limited to the windshield and the combiner, and may have any structure onto which an image output from the HUD 1 is projected.

The HUD 1 includes a liquid crystal display device 10 and a reflective plate 40.

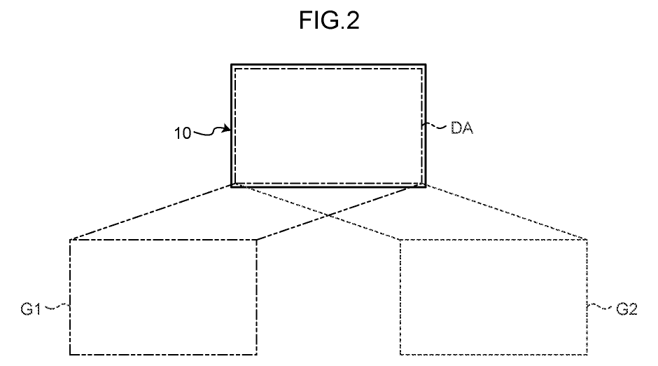

FIG. 2 is a conceptual diagram of the liquid crystal display device 10 illustrated in FIG. 1. A first image G1 and a second image G2 are simultaneously displayed in an entire display region DA of the liquid crystal display device 10 at viewing angles different from each other.

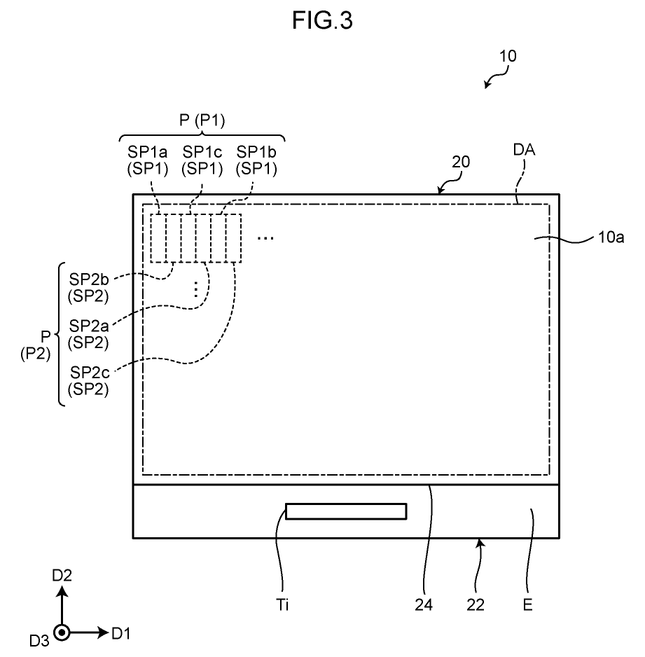

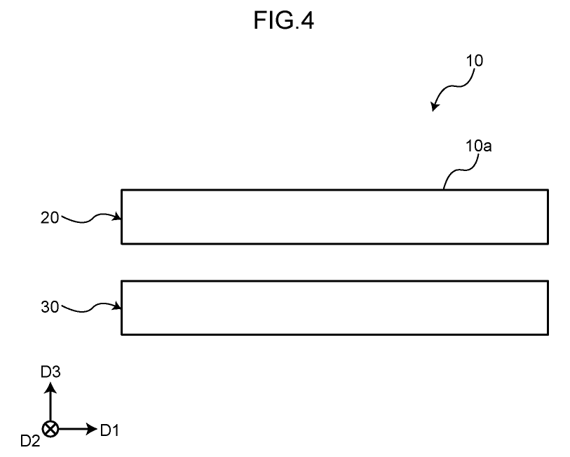

FIG. 3 is a plan view of the liquid crystal display device 10 illustrated in FIG. 1. FIG. 4 is a side view of the liquid crystal display device 10 illustrated in FIG. 3. A first direction D1, a second direction D2, and a third direction D3 (corresponding to "orthogonal directions") illustrated in the drawings are orthogonal to one another and correspond to the depth, width, and height directions, respectively, of the liquid crystal display device 10. In the first direction D1, the side indicated by an arrow corresponds to the positive D1 side of the liquid crystal display device 10, and the opposite side corresponds to the negative D1 side of the liquid crystal display device 10. In the second direction D2, the side indicated by an arrow corresponds to the positive D2 side of the liquid crystal display device 10, and the opposite side corresponds to the negative D2 side of the liquid crystal display device 10. In the third direction D3, the side indicated by an arrow corresponds to the positive D3 side (upper side) of the liquid crystal display device 10, and the opposite side corresponds to the negative D3 side (lower side) of the liquid crystal display device 10. The first direction D1, the second direction D2, and the third direction D3 are exemplary, and the present disclosure is not limited to these directions. In the present specification, "plan view" refers to viewing the liquid crystal display device 10 along the third direction D3.

The liquid crystal display device 10 displays an image based on an image signal output from an external device (for example, car navigation system) electrically coupled to the liquid crystal display device 10 through a flexible wiring substrate (not illustrated). In the first embodiment, the liquid crystal display device 10 is disposed such that the third direction D3 and the Z direction are parallel to each other. The liquid crystal display device 10 is also disposed such that the first direction D1 and the X direction are parallel to each other and the second direction D2 and the Y direction are parallel to each other.

As illustrated in FIG. 4, the liquid crystal display device 10 includes a display panel 20 and a light source device 30.

The display panel 20 is a transmissive liquid crystal display. The display panel 20 may be, for example, an organic or inorganic EL display. As illustrated in FIG. 3, the display panel 20 has a display surface 10a with the display region DA in which an image is displayed. The display surface 10a is flat and planar. The display surface 10a is orthogonal to the third direction D3.

The display panel 20 includes a plurality of pixels P disposed in a matrix of rows and columns in plan view. The row direction is parallel to the first direction D1. The column direction is parallel to the second direction D2. The pixels P overlap the display region DA in plan view. The pixels P include first pixels P1 and second pixels P2.

The first pixels P1 are pixels corresponding to the first image G1. Each first pixel P1 includes a first-type first sub pixel SP1a, a second-type first sub pixel SP1b, and a third-type first sub pixel SP1c. The first-type first sub pixel SP1a is a red sub pixel. The second-type first sub pixel SP1b is a green sub pixel. The third-type first sub pixel SP1c is a blue sub pixel. Hereinafter, the first-type first sub pixel SP1a, the second-type first sub pixel SP1b, and the third-type first sub pixel SP1c are simply referred to as "first sub pixels SP1" when not distinguished in description.

The second pixels P2 are pixels corresponding to the second image G2. Each second pixel P2 includes a first-type second sub pixel SP2a, a second-type second sub pixel SP2b, and a third-type second sub pixel SP2c. The first-type second sub pixel SP2a is a red sub pixel. The second-type second sub pixel SP2b is a green sub pixel. The third-type second sub pixel SP2c is a blue sub pixel. Hereinafter, the first-type second sub pixel SP2a, the second-type second sub pixel SP2b, and the third-type second sub pixel SP2c are simply referred to as "second sub pixels SP2" when not distinguished in description.

In this manner, each first pixel P1 includes the three first sub pixels SP1, and each second pixel P2 includes the three second sub pixels SP2. The number and colors of the first sub pixels SP1 and the number and colors of the second sub pixels SP2 are not limited to the above-described numbers and colors.

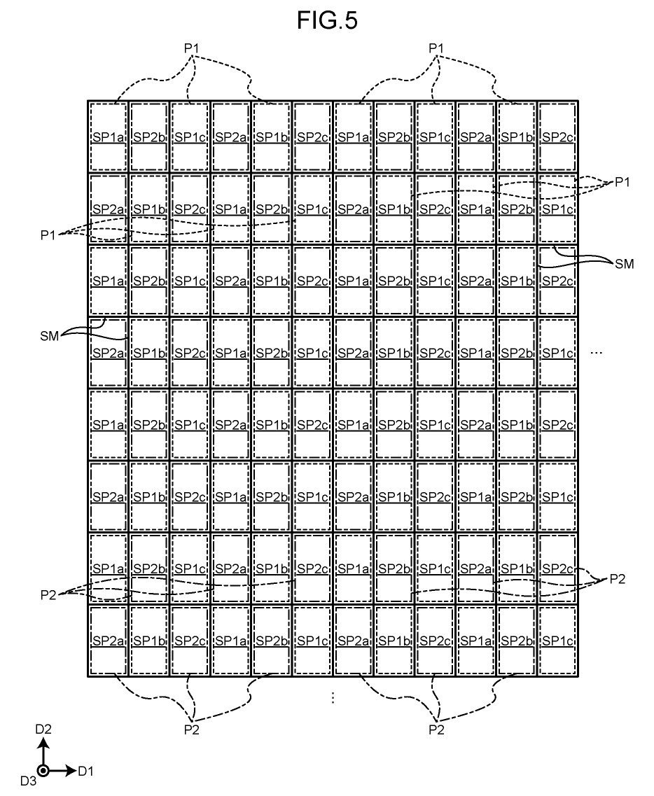

FIG. 5 is a diagram illustrating an arrangement of the first sub pixels SP1 and the second sub pixels SP2 illustrated in FIG. 3. In FIG. 5, each first sub pixel SP1 is indicated with a quadrilateral shape illustrated by dashed lines, and each second sub pixel SP2 is indicated with a quadrilateral shape illustrated by dashed and single-dotted lines.

The first pixels P1 and the second pixels P2 are each disposed in the row direction (first direction D1). The first pixels P1 and the second pixels P2 are each disposed in zigzag shapes in the column direction (second direction D2).

Focusing on the first pixels P1 arranged in the row direction, the first-type first sub pixel SP1a, the third-type first sub pixel SP1c, and the second-type first sub pixel SP1b are repeatedly disposed in the stated order in the row direction. Focusing on the second pixels P2 arranged in the row direction, the second-type second sub pixel SP2b, the first-type second sub pixel SP2a, and the third-type second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-type first sub pixel SP1a is adjacent to at least one of the second-type second sub pixel SP2b and the third-type second sub pixel SP2c in the row direction. The second-type first sub pixel SP1b is adjacent to at least one of the third-type second sub pixel SP2c and the first-type second sub pixel SP2a in the row direction. The third-type first sub pixel SP1c is adjacent to at least one of the first-type second sub pixel SP2a and the second-type second sub pixel SP2b in the row direction.

The first-type second sub pixel SP2a is adjacent to at least one of the second-type first sub pixel SP1b and the third-type first sub pixel SP1c in the row direction. The second-type second sub pixel SP2b is adjacent to at least one of the third-type first sub pixel SP1c and the first-type first sub pixel SP1a in the row direction. The third-type second sub pixel SP2c is adjacent to at least one of the first-type first sub pixel SP1a and the second-type first sub pixel SP1b in the row direction.

The first sub pixels SP1 and the second sub pixels SP2 are alternately arranged in the column direction. That is, the first sub pixels SP1 and the second sub pixels SP2 are adjacent to each other in the column direction. Specifically, the first-type first sub pixel SP1a and the first-type second sub pixel SP2a are alternately arranged in the column direction. The second-type first sub pixel SP1b and the second-type second sub pixel SP2b are alternately arranged in the column direction. The third-type first sub pixel SP1c and the third-type second sub pixel SP2c are alternately arranged in the column direction.

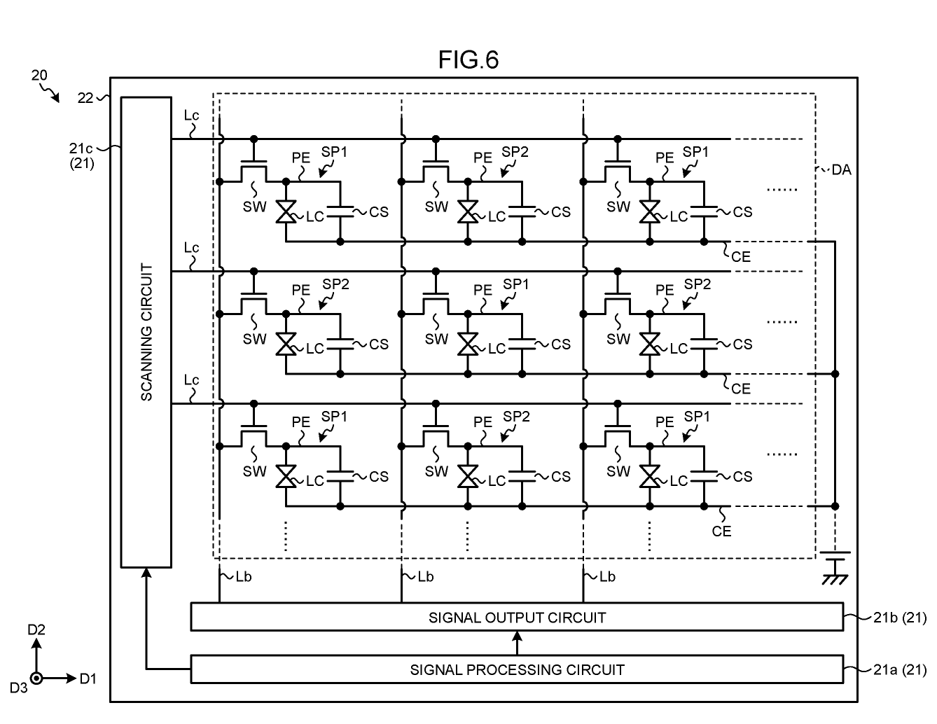

FIG. 6 is a diagram illustrating a circuit configuration of the display panel 20 illustrated in FIG. 3. The display panel 20 includes a drive circuit 21, and a switching element SW, a sub pixel electrode PE, a common electrode CE, a liquid crystal capacitor (capacitance) LC, and a storage capacitor CS provided in each of the first sub pixels SP1 and the second sub pixels SP2. The first sub pixels SP1 and the second sub pixels SP2 are configured in the same manner.

The drive circuit 21 drives the display panel 20. The drive circuit 21 includes a signal processing circuit 21a, a signal output circuit 21b, and a scanning circuit 21c.

The signal processing circuit 21a outputs first sub pixel signals indicating the gradations of the first sub pixels SP1 and second sub pixel signals indicating the gradations of the second sub pixels SP2 to the signal output circuit 21b based on an image signal transmitted from an external device. The signal processing circuit 21a also outputs a clock signal synchronizing operation of the signal output circuit 21b and operation of the scanning circuit 21c to the signal output circuit 21b and the scanning circuit 21c.

The signal output circuit 21b outputs the first sub pixel signals to the first sub pixels SP1 and outputs the second sub pixel signals to the second sub pixels SP2. The signal output circuit 21b is electrically coupled to the first sub pixels SP1 and the second sub pixels SP2 through a plurality of signal lines Lb extending in the second direction D2.

The scanning circuit 21c scans the first sub pixels SP1 and the second sub pixels SP2 in synchronization with the outputting of the first sub pixel signals and the second sub pixel signals from the signal output circuit 21b. The scanning circuit 21c is electrically coupled to the first sub pixels SP1 and the second sub pixels SP2 through a plurality of scanning lines Lc extending in the first direction D1.

In plan view, a region partitioned by two signal lines Lb adjacent to each other in the first direction D1 and two scanning lines Lc adjacent to each other in the second direction D2 corresponds to one of the first sub pixels SP1 and the second sub pixels SP2.

The switching element SW includes, for example, a thin film transistor (TFT). The switching element SW has a source electrode electrically coupled to a signal line Lb, and a gate electrode electrically coupled to a scanning line Lc.

The sub pixel electrode PE is coupled to a drain electrode of the switching element SW. A plurality of the common electrodes CE are disposed corresponding to the scanning lines Lc. The sub pixel electrode PE and the common electrode CE have a light-transmitting property.

The liquid crystal capacitor (capacitance) LC is a capacitive component of a liquid crystal material of a liquid crystal layer 23 to be described later between the sub pixel electrode PE and the common electrode CE. The storage capacitor CS is disposed between an electrode at the same potential as the common electrode CE and an electrode at the same potential as the sub pixel electrode PE.

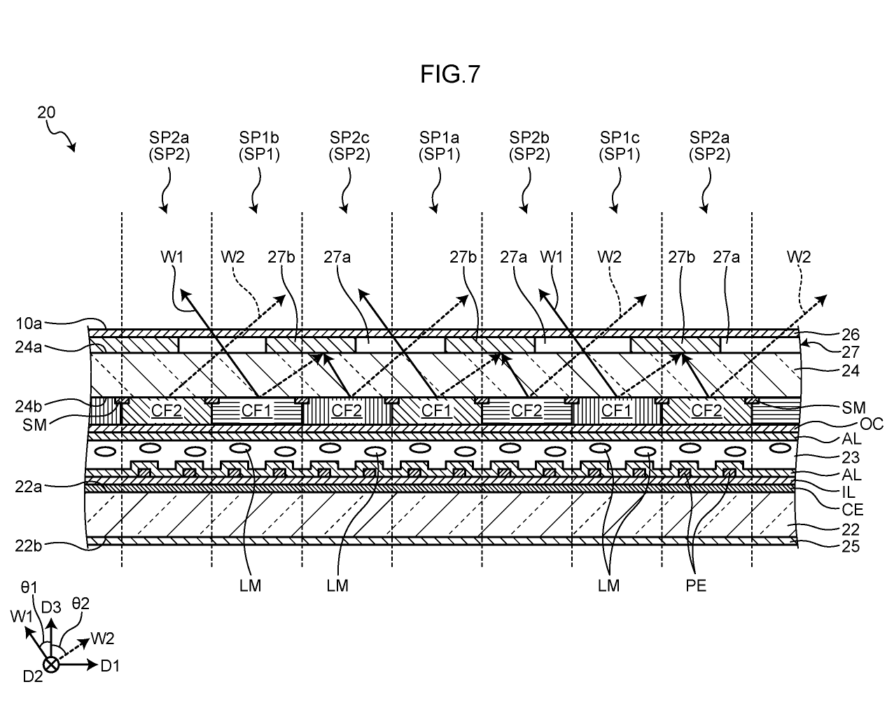

FIG. 7 is a sectional view of the display panel 20 illustrated in FIG. 3. The display panel 20 further includes a first substrate 22, a liquid crystal layer 23, and a second substrate 24. The first substrate 22, the liquid crystal layer 23, and the second substrate 24 have a light-transmitting property and are disposed in the stated order from the negative D3 side toward the positive D3 side in the third direction D3. The first substrate 22 and the second substrate 24 have quadrilateral shapes in plan view. The shapes of the first substrate 22 and the second substrate 24 in plan view may be other than quadrilateral shapes, such as circular or trapezoid shapes.

The common electrode CE is disposed on a principal surface 22a of the first substrate 22 on the positive D3 side. An insulating layer IL is disposed on the positive D3 side of the common electrode CE, and in addition, the sub pixel electrode PE and an alignment film AL are disposed thereon.

The sub pixel electrode PE is disposed between the insulating layer IL and the alignment film AL. In this manner, the common electrode CE and the sub pixel electrode PE are disposed on the first substrate 22. That is, the display panel 20 is a liquid crystal display of a horizontal electric field type.

The second substrate 24 is positioned on the positive D3 side of the first substrate 22. An overcoat layer OC, first color filters CF1, second color filters CF2, a light-shielding film SM, and an alignment film AL are disposed on a lower surface 24b side of the second substrate 24. The light-shielding film SM, the first color filters CF1, the second color filters CF2, and the overcoat layer OC are disposed between the second substrate 24 and the alignment film AL.

The overcoat layer OC is formed of a material having a light-transmitting property.

The first color filters CF1 and the second color filters CF2 are disposed between the second substrate 24 and the liquid crystal layer 23. The first color filters CF1 are color filters included in the first sub pixels SP1. The second color filters CF2 are color filters included in the second sub pixels SP2.

The first color filters CF1 and the second color filters CF2 have quadrilateral shapes in plan view. Each of the first color filters CF1 and the second color filters CF2 has a light-transmitting property and has a predetermined peak of the spectrum of light to be transmitted. The spectrum peak corresponds to the color of a corresponding one of the first color filters CF1 and the color of the second color filters CF2. That is, light transmitted through the first color filters CF1 and the second color filters CF2 is colored. The shapes of the first color filters CF1 and the second color filters CF2 in plan view may be changed so as to match the shapes of the first sub pixels SP1 and the second sub pixels SP2.

The colors of the first color filters CF1 are the same as the colors of the first sub pixels SP1. The colors of the second color filters CF2 are the same as the colors of the second sub pixels SP2. Specifically, each red first-type first sub pixel SP1a includes a red first color filter CF1, each green second-type first sub pixel SP1b includes a green first color filter CF1, and each blue third-type first sub pixel SP1c includes a blue first color filter CF1. Each red first-type second sub pixel SP2a includes a red second color filter CF2, each green second-type second sub pixel SP2b includes a green second color filter CF2, and each blue third-type second sub pixel SP2c includes a blue second color filter CF2.

The light-shielding film SM is light-shielding and overlaps the boundary of a first sub pixel SP1 and the boundary of a second sub pixel SP2 adjacent to each other in the first direction D1 and the second direction D2 in plan view. In other words, the light-shielding film SM overlaps the signal lines Lb and the scanning lines Lc in plan view. In FIG. 7, illustrations of the signal lines Lb and the scanning lines Lc are omitted. The signal lines Lb and the scanning lines Lc are disposed on the principal surface 22a of the first substrate 22. In FIG. 5, solid lines partitioning the first sub pixels SP1 and the second sub pixels SP2 correspond to the light-shielding film SM. The peripheries of the first color filters CF1 and the peripheries of the second color filters CF2 overlap the light-shielding film SM in plan view.

As illustrated in FIG. 7, the liquid crystal layer 23 is disposed between the first substrate 22 and the second substrate 24. The liquid crystal layer 23 contains a plurality of liquid crystal molecules LM. The liquid crystal layer 23 overlaps the display region DA in plan view. Specifically, the liquid crystal layer 23 is disposed between the two alignment films AL facing each other. The initial alignment of the liquid crystal molecules LM is determined by the two alignment films AL facing each other.

The display panel 20 further includes a first polarizing plate 25, a second polarizing plate 26, and a parallax barrier 27.

The first polarizing plate 25 is disposed on a lower surface 22b of the first substrate 22. The first polarizing plate 25 has a transmission axis orthogonal to the third direction D3. The second polarizing plate 26 is disposed on an upper surface 24a of the second substrate 24. The second polarizing plate 26 has a transmission axis orthogonal to the transmission axis of the first polarizing plate 25 and the third direction D3. An upper surface of the second polarizing plate 26 corresponds to the display surface 10a.

The parallax barrier 27 is disposed between the second substrate 24 and the second polarizing plate 26. The parallax barrier 27 is plate-shaped. The parallax barrier 27 is disposed on the surface (upper surface 24a) of the second substrate 24 on the side opposite a surface (the lower surface 24b) facing the first color filters CF1 and the second color filters CF2. The parallax barrier 27 includes a plurality of openings 27a and a light-shielding part 27b.

The openings 27a pass light traveling in a first emission direction W1 among light transmitted through the first color filters CF1. The first emission direction W1 is a direction indicated by solid lines in FIG. 7 and tilted to the negative D1 side relative to the third direction D3. The first emission direction W1 is orthogonal to the second direction D2. The first emission direction W1 is a direction toward the light-transmitting body 2 (refer to FIG. 1).

The openings 27a pass light traveling in a second emission direction W2 different from the first emission direction W1 among light transmitted through the second color filters CF2. The second emission direction W2 is a direction indicated by dashed lines in FIG. 7 and tilted to the positive D1 side relative to the third direction D3. The second emission direction W2 is orthogonal to the second direction D2. A first angle θ1 between the first emission direction W1 and the third direction D3 is different from a second angle θ2 between the second emission direction W2 and the third direction D3.

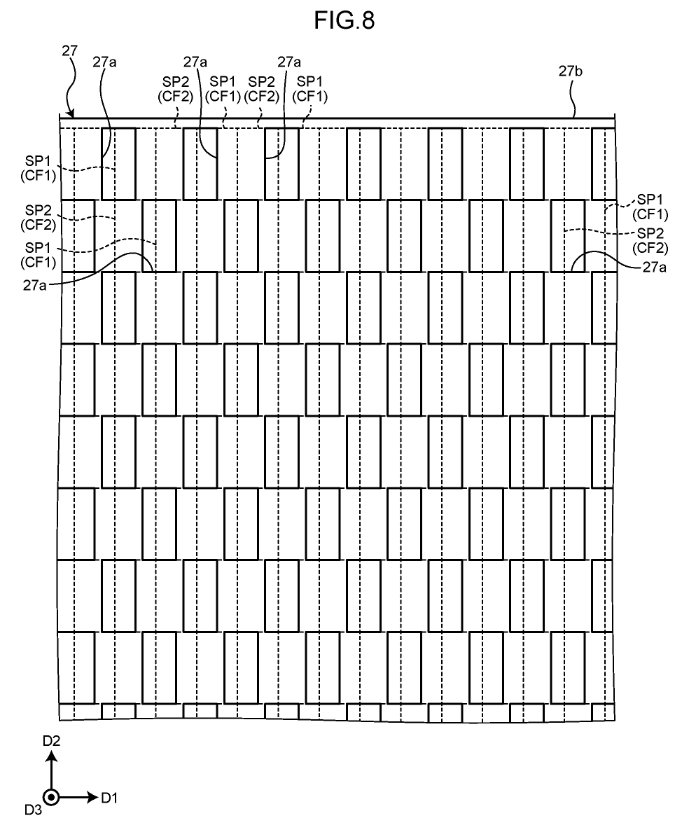

FIG. 8 is a plan view of the parallax barrier 27 illustrated in FIG. 7. In FIG. 8, the first sub pixels SP1 and the second sub pixels SP2 are illustrated with dashed lines. As illustrated in FIGS. 7 and 8, in plan view, each opening 27a overlaps the first color filter CF1 of a first sub pixel SP1 and the second color filter CF2 of a second pixel P2 adjacent to each other in the row direction. In the plan view illustrated in FIG. 8, each opening 27a overlaps the negative D1 side of a first color filter CF1 and the positive D1 side of a second color filter CF2.

As illustrated in FIG. 8, the openings 27a are disposed in the row direction in plan view. The openings 27a are also disposed in zigzag shapes in the column direction in plan view.

The light-shielding part 27b illustrated in FIGS. 7 and 8 is formed of a material with high light absorption (for example, metallic chromium (Cr), chromium oxide (CrO₂), or resin). The light-shielding part 27b blocks light traveling in the second emission direction W2 among light transmitted through the first color filters CF1. The light-shielding part 27b blocks light traveling in the first emission direction W1 among light transmitted through the second color filters CF2.

As illustrated in FIG. 3, the first substrate 22 includes an exposed part E that is exposed from the second substrate 24 in plan view. The exposed part E is positioned on the negative D2 side relative to the second substrate 24 in plan view. An IC chip Ti including the drive circuit 21 is disposed on the upper surface of the exposed part E. An upper surface of the exposed part E is part of the principal surface 22a of the first substrate 22.

As illustrated in FIG. 4, the light source device 30 is disposed on the negative D3 side relative to the display panel 20. The light source device 30 emits light toward the display panel 20. The light source device 30 is, for example, a direct-type backlight and includes a plurality of light-emitting diodes (not illustrated).

The following describes operation of the liquid crystal display device 10 when the first image G1 and the second image G2 are displayed in the display region DA.

Upon acquiring an image signal transmitted from an external device, the liquid crystal display device 10 displays the first image G1 and the second image G2 in the display region DA. The image signal includes the gradations of the first sub pixels SP1 corresponding to the first image G1 and the gradations of the second sub pixels SP2 corresponding to the second image G2. As described above, the first sub pixel signals indicating the gradations of the first sub pixels SP1 are output to the first sub pixels SP1, and the second sub pixel signals indicating the gradations of the second sub pixels SP2 are output to the second sub pixels SP2.

Voltages corresponding to the gradations indicated by the first sub pixel signals are applied to regions of the liquid crystal layer 23 corresponding to the first sub pixels SP1, and the liquid crystal molecules LM are tilted. The degree of tilt of the liquid crystal molecules LM changes with the gradations indicated by the first sub pixel signals. Light emitted from the light source device 30 and transmitted through the regions of the liquid crystal layer 23 corresponding to the first sub pixels SP1 is modulated to the gradations indicated by the first sub pixel signals. In addition, the light transmitted through the regions of the liquid crystal layer 23 corresponding to the first sub pixels SP1 is colored by being transmitted through the first color filters CF1. The light transmitted through the display panel 20 via the first color filters CF1 corresponds to the first image G1.

Light traveling in the second emission direction W2 among the light transmitted through the first color filters CF1 is blocked by the light-shielding part 27b. Accordingly, the light traveling in the second emission direction W2 among the light transmitted through the first color filters CF1 is not visually recognizable.

However, light traveling in the first emission direction W1 (hereinafter referred to as first light L1; refer to FIG. 1) among the light transmitted through the first color filters CF1 passes through the openings 27a of the parallax barrier 27 and is externally emitted from the display surface 10a. Thus, the first light L1 is visually recognizable as the first image G1.

Voltages corresponding to the gradations indicated by the second sub pixel signals are applied to regions of the liquid crystal layer 23 corresponding to the second sub pixels SP2, and the liquid crystal molecules LM are tilted. The degree of tilt of the liquid crystal molecules LM changes with the gradations indicated by the second sub pixel signals. Light transmitted through the regions of the liquid crystal layer 23 corresponding to the second sub pixels SP2 is modulated to the gradations indicated by the second sub pixel signals. In addition, the light transmitted through the regions of the liquid crystal layer 23 corresponding to the second sub pixels SP2 is colored by being transmitted through the second color filters CF2. The light transmitted through the display panel 20 via the second color filters CF2 corresponds to the second image G2.

Light traveling in the first emission direction W1 among the light transmitted through the second color filters CF2 is blocked by the light-shielding part 27b. Accordingly, the light traveling in the first emission direction W1 among the light transmitted through the second color filters CF2 is not visually recognizable.

However, light traveling in the second emission direction W2 (hereinafter referred to as second light L2; refer to FIG. 1) among the light transmitted through the second color filters CF2 passes through the openings 27a of the parallax barrier 27 and is externally emitted from the display surface 10a. Thus, the second light L2 is visually recognizable as the second image G2.

In this manner, the parallax barrier 27 makes the viewing angle of the first image G1 and the viewing angle of the second image G2 different from each other. Moreover, as described above, the first sub pixels SP1 and the second sub pixels SP2 are disposed across the entire display region DA. Accordingly, the first image G1 corresponding to the first light L1 and the second image G2 corresponding to the second light L2 are simultaneously displayed in the entire display region DA of the display surface 10a.

As illustrated in FIG. 1, the first light L1 emitted from the display surface 10a travels in the first emission direction W1 toward the light-transmitting body 2 and is projected onto the light-transmitting body 2. The viewer directing a sight line Lv to the first light L1 projected onto the light-transmitting body 2 visually recognizes the first image G1 as a first virtual image VG1.

The first virtual image VG1 is visually recognized by the viewer in a state of being substantially perpendicular to the sight line Lv of the viewer. The sight line Lv of the viewer is substantially parallel to the X direction. The first virtual image VG1 is orthogonal to the X direction. The first image G1 displayed on the display surface 10a and the first virtual image VG1 are line-symmetric to each other with respect to the light-transmitting body 2 serving as a symmetry axis. In other words, the tilt degree of the light-transmitting body 2, the tilt degree of the display surface 10a, and the first angle θ1 are set such that the first virtual image VG1 is visually recognized in a state of being orthogonal to the X direction.

The second light L2 emitted from the display surface 10a is incident on the reflective plate 40.

The reflective plate 40 is, for example, a mirror. The reflective plate 40 has a reflection surface 41 on which the second light L2 emitted from the display surface 10a of the liquid crystal display device 10 is incident. The reflection surface 41 reflects the second light L2 along the first emission direction W1 toward the light-transmitting body 2. In other words, the second angle θ2 and the tilt degree (posture) of the reflective plate 40 are set such that the second light L2 reflected by the reflection surface 41 travels along the first emission direction W1 toward the light-transmitting body 2.

The second light L2 reflected by the reflective plate 40 travels along the first emission direction W1 and is projected onto the light-transmitting body 2. The viewer directing the sight line Lv to the second light L2 projected onto the light-transmitting body 2 visually recognizes the second image G2 as a second virtual image VG2. The second virtual image VG2 is visually recognized by the viewer in a state of not overlapping the first virtual image VG1 but being adjacent thereto. The second virtual image VG2 is also visually recognized by the viewer in a state of being tilted relative to the first virtual image VG1.

When an image that is line-symmetric with respect to the second image G2 displayed on the display surface 10a with respect to the reflection surface 41 serving as a symmetry axis is defined as a tentative virtual image TG, the second virtual image VG2 and the tentative virtual image TG are line-symmetric to each other with respect to the light-transmitting body 2 serving as a symmetry axis. Moreover, the tentative virtual image TG is tilted relative to the second virtual image VG2 displayed on the display surface 10a. Accordingly, the second virtual image VG2 is tilted relative to the first virtual image VG1.

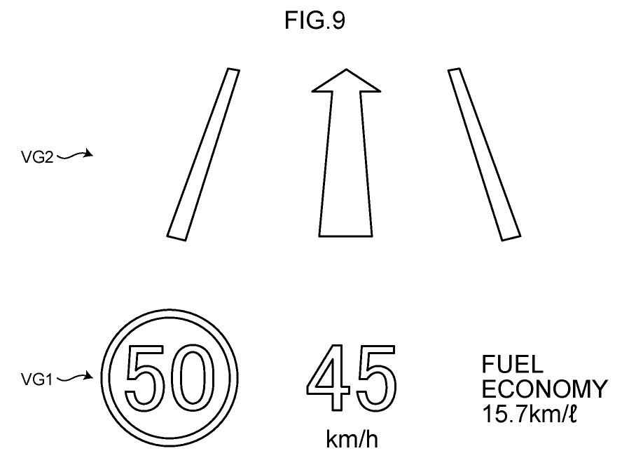

FIG. 9 is a diagram illustrating the first virtual image VG1 and the second virtual image VG2 visually recognized by the viewer in the head-up display 1 illustrated in FIG. 1. In the example illustrated in FIG. 9, the first image G1 includes characters and symbols indicating the vehicle speed and the speed limit. The second image G2 includes an arrow indicating the vehicle traveling direction and straight lines indicating a roadway.

The first virtual image VG1 corresponding to the first image G1 is visually recognized by the viewer in a state of being substantially perpendicular to the sight line Lv of the viewer as described above. Thus, the viewer can appropriately visually recognize the characters, symbols, and/or the like indicating the vehicle speed, the speed limit, and/or the like.

The second virtual image VG2 corresponding to the second image G2 is visually recognized by the viewer in a state of being tilted relative to the first virtual image VG1 as described above. Accordingly, the arrow indicating the vehicle traveling direction and the straight lines indicating a roadway, which are included in the second virtual image VG2, are visually recognized by the viewer in a state of having depth. Thus, the viewer can appropriately understand the vehicle traveling direction based on the second virtual image VG2.

In this manner, in the above-described HUD 1, the first light L1 and the second light L2 are emitted from the planar display surface 10a in directions different from each other, whereby the first virtual image VG1 and the second virtual image VG2 having tilt degrees different from each other can be visually recognized by the viewer. Thus, the HUD 1 can achieve downsizing as compared to a case where the first virtual image VG1 and the second virtual image VG2 having tilt degrees different from each other are visually recognized by the viewer by using a plurality of display surfaces having tilt degrees different from each other.

### Second Embodiment

The following describes the HUD 1 according to a second embodiment of the present disclosure with focus on any difference from the HUD 1 of the above-described first embodiment.

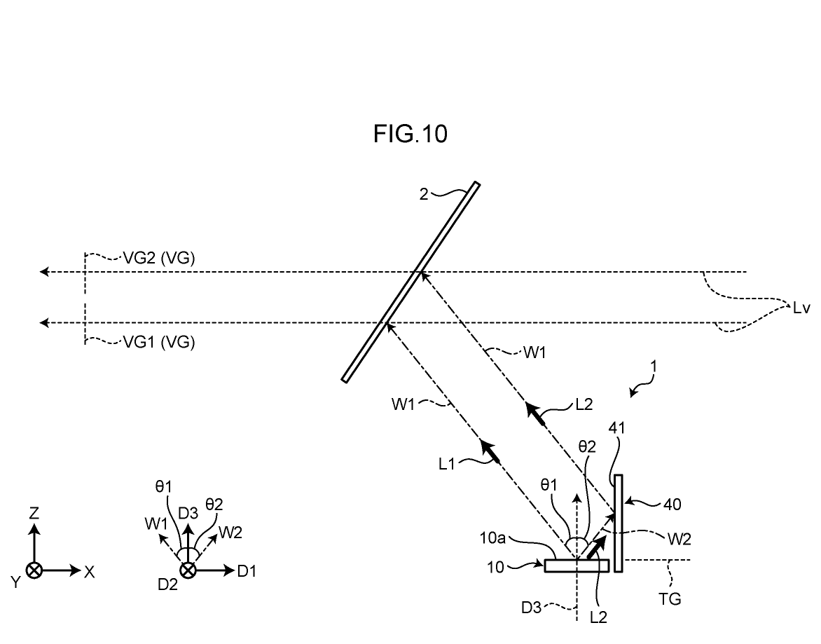

FIG. 10 is a schematic diagram of the head-up display 1 according to the second embodiment of the present disclosure. In the HUD 1 of the second embodiment, the first angle θ1 between the third direction D3 and the first emission direction W1 is equal to the second angle θ2 between the third direction D3 and the second emission direction W2. Moreover, the reflective plate 40 is disposed such that the reflection surface 41 is perpendicular to the display surface 10a (parallel to the third direction D3).

In this case, the tentative virtual image TG is parallel to the second image G2 displayed on the display surface 10a. As described above, the second virtual image VG2 and the tentative virtual image TG are line-symmetric to each other with respect to the light-transmitting body 2 serving as a symmetry axis. Moreover, the first image G1 displayed on the display surface 10a and the first virtual image VG1 are line-symmetric to each other with respect to the light-transmitting body 2 serving as a symmetry axis. Accordingly, the tilt degree of the first virtual image VG1 is equal to the tilt degree of the second virtual image VG2. As in the above-described first embodiment, the second virtual image VG2 is visually recognized by the viewer in a state of not overlapping the first virtual image VG1 but being adjacent thereto.

In this manner, in the HUD 1 of the second embodiment, the first light L1 and the second light L2 are emitted from one display surface 10a such that the first virtual image VG1 and the second virtual image VG2 are visually recognized by the viewer in a state of having tilt degrees equal to each other and being adjacent to each other.

The HUD 1 allows visual recognition of a virtual image in a wider area than in a case where light is not emitted in two directions from one display surface 10a but light traveling only in one direction (for example, the first emission direction W1) is emitted to allow visual recognition of a virtual image corresponding to the light.

### Third Embodiment

The following describes the HUD 1 according to a third embodiment of the present disclosure with focus on any difference from the HUD 1 of the above-described first embodiment.

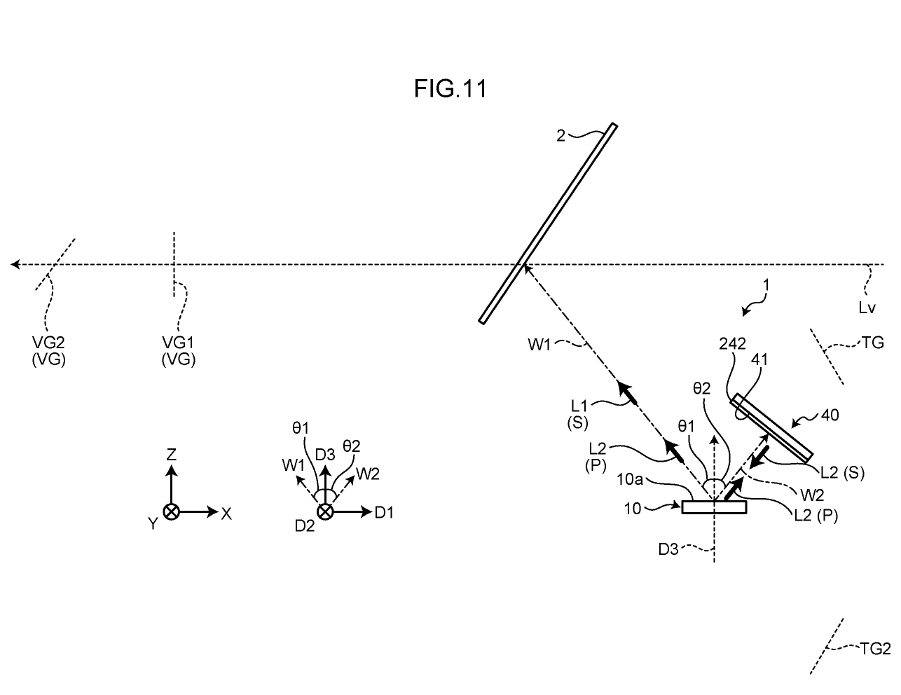

FIG. 11 is a schematic diagram of the head-up display 1 according to the third embodiment of the present disclosure. In the HUD 1 of the third embodiment, the first angle θ1 between the first emission direction W1 and the third direction D3 is equal to the second angle θ2 between the second emission direction W2 and the third direction D3.

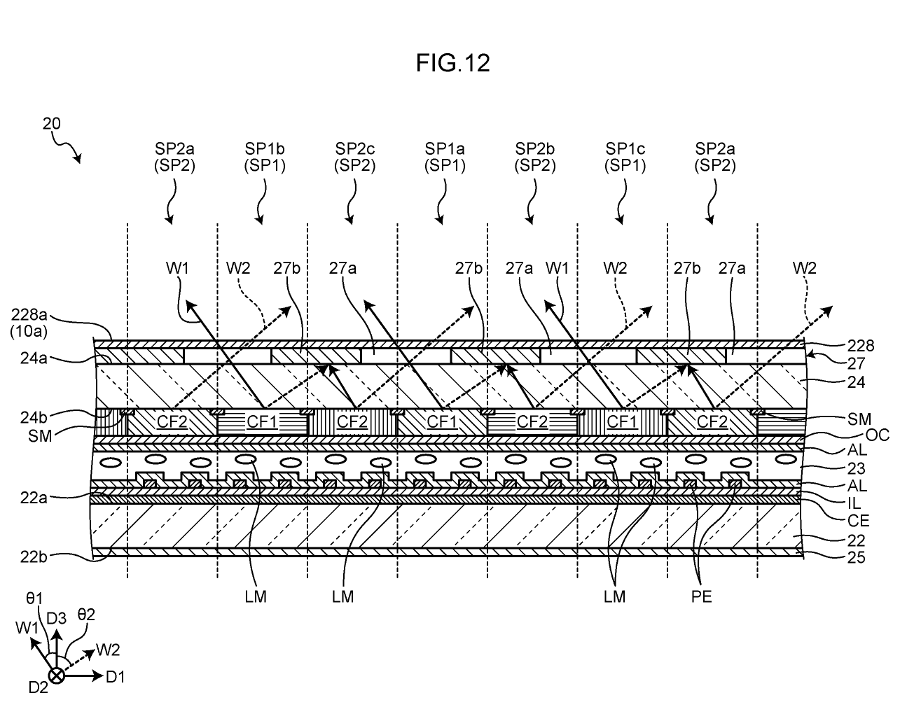

FIG. 12 is a sectional view of the display panel 20 included in the liquid crystal display device 10 illustrated in FIG. 11. In the third embodiment, the liquid crystal display device 10 includes a reflective polarizing plate 228 in place of the second polarizing plate 26 of the above-described first embodiment. An upper surface 228a of the reflective polarizing plate 228 corresponds to the display surface 10a.

The reflective polarizing plate 228 has a polarization axis along which linearly polarized light having a first polarization direction is transmitted. The polarization axis of the reflective polarizing plate 228 is parallel to the transmission axis of the second polarizing plate 26 of the above-described first embodiment. The first light L1 and the second light L2 emitted from the display surface 10a are light transmitted along the polarization axis of the reflective polarizing plate 228. In other words, the first light L1 and the second light L2 emitted from the display surface 10a are linearly polarized light having the first polarization direction parallel to the polarization axis of the reflective polarizing plate 228. The first polarization direction is orthogonal to the first emission direction W1 and the second emission direction W2. In FIG. 11, reference signs "L1(S)" and "L2(S)" denote the first light L1 and the second light L2 having the first polarization direction.

The upper surface 228a of the reflective polarizing plate 228 reflects linearly polarized light having a second polarization direction orthogonal to the first polarization direction. The second polarization direction is orthogonal to the first emission direction W1 and the second emission direction W2.

As illustrated in FIG. 11, the reflective plate 40 is disposed in a state in which the reflection surface 41 and the display surface 10a face each other and the reflection surface 41 is orthogonal to the second emission direction W2. With this configuration, the second light L2 incident on the reflective plate 40 is reflected by the reflection surface 41 in the second emission direction W2 toward the display surface 10a of the liquid crystal display device 10.

A 1/4 wave plate 242 is disposed on the reflection surface 41 of the reflective plate 40. Light transmitted through the 1/4 wave plate 242 is imparted with a phase difference of 1/4 wavelength.

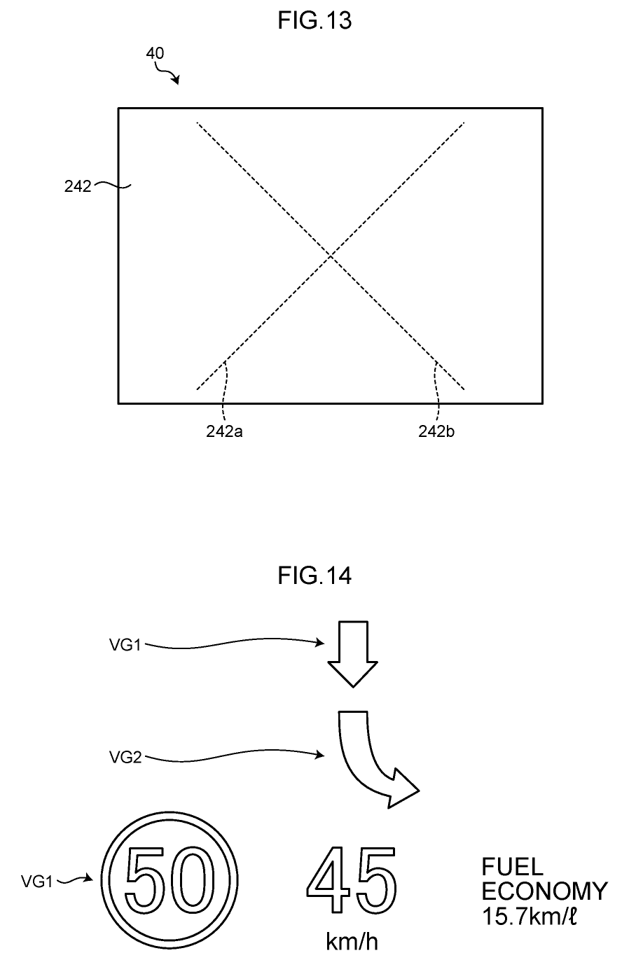

FIG. 13 is a diagram of the 1/4 wave plate 242 illustrated in FIG. 11 when viewed along a direction orthogonal to the reflection surface 41. A fast axis 242a and a slow axis 242b of the 1/4 wave plate 242 are tilted by 45° relative to the second polarization direction.

As illustrated in FIG. 11, in the third embodiment, as in the above-described first embodiment, the first light L1 travels in the first emission direction W1 toward the light-transmitting body 2 and is projected onto the light-transmitting body 2. The first virtual image VG1 is orthogonal to the X direction.

In the third embodiment, the second light L2 emitted from the display surface 10a travels in the second emission direction W2 and is incident on the 1/4 wave plate 242 of the reflective plate 40. The second light L2 is imparted with a phase difference of 1/4 wavelength by the 1/4 wave plate 242 and reflected by the reflection surface 41. The second light L2 reflected by the reflection surface 41 is incident on the 1/4 wave plate 242 and further imparted with a phase difference of 1/4 wavelength. Accordingly, the second light L2 emitted from the display surface 10a is imparted with a phase difference of 1/2 wavelength (= 2×(1/4 wavelength)) by being reflected by the reflective plate 40.

As described above, the second light L2 emitted from the display surface 10a is linearly polarized light having the first polarization direction. Accordingly, the second light L2 reflected by the reflective plate 40 is linearly polarized light having the second polarization direction orthogonal to the first polarization direction. In FIG. 11, reference sign "L2(P)" denotes the second light L2 having the second polarization direction.

As described above, the reflection surface 41 is orthogonal to the second emission direction W2. Accordingly, the second light L2 reflected by the reflective plate 40 travels in the second emission direction W2. In this manner, the reflective plate 40 has the reflection surface 41 that reflects light transmitted through the 1/4 wave plate 242, in the second emission direction W2 toward the display surface 10a through the 1/4 wave plate 242.

The second light L2 reflected by the reflective plate 40 is incident on the upper surface 228a of the reflective polarizing plate 228 along the second emission direction W2. The second light L2 incident on the upper surface 228a of the reflective polarizing plate 228 has the second polarization direction and is reflected by the upper surface 228a of the reflective polarizing plate 228. The first angle θ1 and the second angle θ2 are equal to each other. Accordingly, the second light L2 reflected by the upper surface 228a of the reflective polarizing plate 228 travels in the first emission direction W1 toward the light-transmitting body 2 and is projected onto the light-transmitting body 2.

When an image that is line-symmetric to the tentative virtual image TG with respect to the display surface 10a serving as a symmetry axis is defined as a second tentative virtual image TG2, the second virtual image VG2 and the second tentative virtual image TG2 are line-symmetric to each other with respect to the light-transmitting body 2 serving as a symmetry axis. Accordingly, the second virtual image VG2 is tilted relative to the first virtual image VG1.

As for the second virtual image VG2, the second light L2 reflected by the upper surface 228a of the reflective polarizing plate 228 is projected onto the light-transmitting body 2. Accordingly, the viewer visually recognizes the second virtual image VG2 in a state of overlapping the first virtual image VG1. Moreover, the optical path length of the second light L2 is longer than the optical path length of the first light L1. Accordingly, the second virtual image VG2 is positioned on the negative X side relative to the first virtual image VG1.

FIG. 14 is a diagram illustrating the first virtual image VG1 and the second virtual image VG2 visually recognized by the viewer in the head-up display 1 illustrated in FIG. 11.

In the example illustrated in FIG. 14, the first image G1 includes characters and symbols indicating the vehicle speed and the speed limit and an arrow indicating the vehicle traveling direction. The second image G2 includes an arrow indicating the vehicle traveling direction. The arrow indicating the vehicle traveling direction, which is included in the first virtual image VG1, and the arrow indicating the vehicle traveling direction, which is included in the second virtual image VG2, are set at positions where they are not visually recognized in a state of overlapping each other by the viewer.

The second virtual image VG2 is tilted relative to the first virtual image VG1, and the viewer visually recognizes the second virtual image VG2 in a state of having a depth with respect to the first virtual image VG1. Accordingly, the viewer recognizes that the arrow indicating the vehicle traveling direction, which is included in the second virtual image VG2, is positioned further ahead in the vehicle traveling direction relative to the arrow indicating the vehicle traveling direction, which is included in the first virtual image VG1. Thus, the viewer can appropriately recognize the vehicle traveling direction based on the first virtual image VG1 and the second virtual image VG2.

### Modifications

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the liquid crystal display device 10 may be disposed in a state in which the third direction D3 and the Z direction are tilted relative to each other. In this case, the first virtual image VG1 may not be orthogonal to the X direction.

The openings 27a may not overlap at least one of the first color filters CF1 and the second color filters CF2 in plan view.

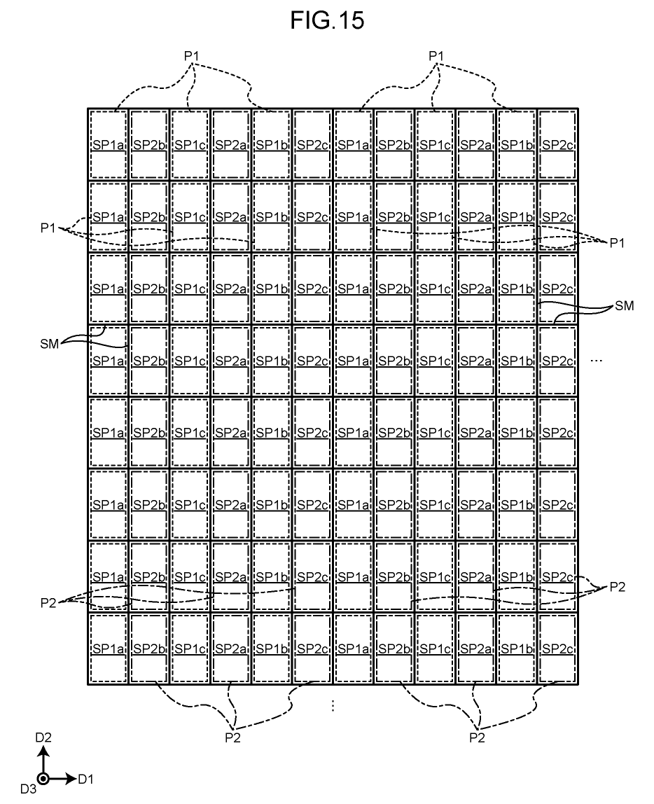

FIG. 15 is a diagram illustrating an arrangement of the first sub pixels SP1 and the second sub pixels SP2 of the liquid crystal display device 10 included in the head-up display 1 according to a modification of the embodiments of the present disclosure.

In the present modification, the first pixels P1 and the second pixels P2 are each disposed in the row direction (first direction D1) and the column direction (second direction D2). Focusing on the first pixels P1 arranged in the row direction, the first-type first sub pixel SP1a, the third-type first sub pixel SP1c, and the second-type first sub pixel SP1b are repeatedly disposed in the stated order in the row direction. Focusing on the second pixels P2 arranged in the row direction, the second-type second sub pixel SP2b, the first-type second sub pixel SP2a, and the third-type second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-type first sub pixel SP1a is adjacent to at least one of the second-type second sub pixel SP2b and the third-type second sub pixel SP2c in the row direction. The second-type first sub pixel SP1b is adjacent to at least one of the third-type second sub pixel SP2c and the first-type second sub pixel SP2a in the row direction. The third-type first sub pixel SP1c is adjacent to at least one of the first-type second sub pixel SP2a and the second-type second sub pixel SP2b in the row direction.

The first-type second sub pixel SP2a is adjacent to at least one of the second-type first sub pixel SP1b and the third-type first sub pixel SP1c in the row direction. The second-type second sub pixel SP2b is adjacent to at least one of the third-type first sub pixel SP1c and the first-type first sub pixel SP1a in the row direction. The third-type second sub pixel SP2c is adjacent to at least one of the first-type first sub pixel SP1a and the second-type first sub pixel SP1b in the row direction.

The first sub pixels SP1 are disposed in the column direction. Specifically, the first-type first sub pixels SP1a are disposed in a state of being adjacent to each other in the column direction. The second-type first sub pixels SP1b are disposed in a state of being adjacent to each other in the column direction. The third-type first sub pixels SP1c are disposed in a state of being adjacent to each other in the column direction.

The second sub pixels SP2 are disposed in the column direction. Specifically, the first-type second sub pixels SP2a are disposed in a state of being adjacent to each other in the column direction. The second-type second sub pixels SP2b are disposed in a state of being adjacent to each other in the column direction. The third-type second sub pixels SP2c are disposed in a state of being adjacent to each other in the column direction.

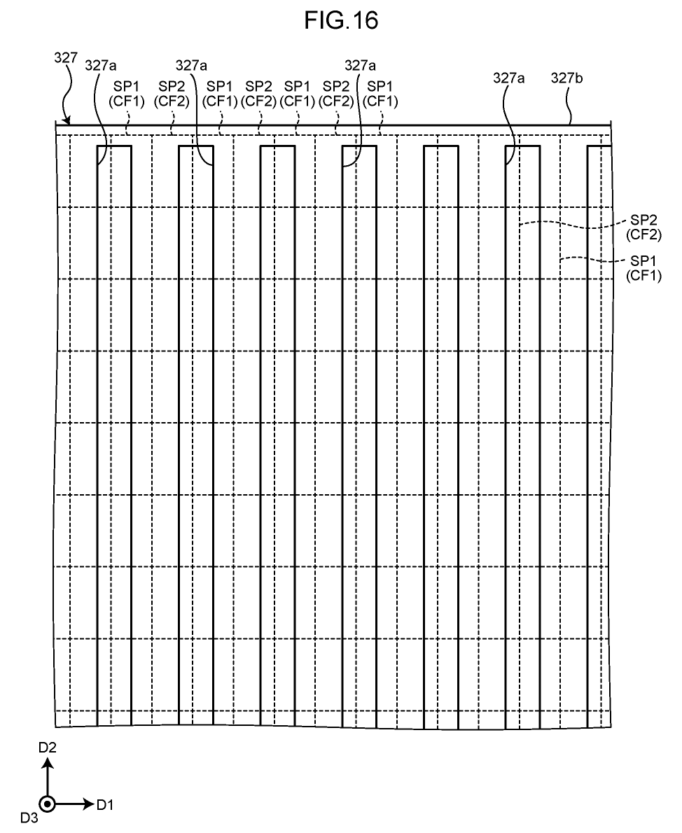

FIG. 16 is a plan view of a parallax barrier 327 of the liquid crystal display device 10 included in the head-up display 1 according to the modification of the embodiments of the present disclosure. The parallax barrier 327 of the present modification corresponds to the arrangement of the first sub pixels SP1 and the second sub pixels SP2 illustrated in FIG. 15. The parallax barrier 327 includes openings 327a and a light-shielding part 327b.

In FIG. 16, the first sub pixels SP1 and the second sub pixels SP2 are illustrated with dashed lines. In the present modification, each opening 327a overlaps one first color filter CF1 and one second color filter CF2 adjacent to each other in the row direction in plan view. In the plan view illustrated in FIG. 16, as in the above-described embodiment, each opening 327a overlaps the negative D1 side of a first color filter CF1 and the positive D1 side of a second color filter CF2.

Each opening 327a has a shape extending in the column direction (second direction D2). Each opening 327a overlaps a plurality of first sub pixels SP1 arranged in the column direction and a plurality of second sub pixels SP2 arranged in the column direction in plan view. The openings 327a are disposed in a plurality in the row direction (first direction D1).

Since the first sub pixels SP1, the second sub pixels SP2, and the openings 327a are disposed as illustrated in FIGS. 15 and 16, the viewing angle of the first image G1 and the viewing angle of the second image G2 are different from each other as in each above-described embodiment. In the present modification as well, the first sub pixels SP1 and the second sub pixels SP2 are disposed across the entire display region DA. Accordingly, the first image G1 and the second image G2 are simultaneously displayed in the entire display region DA.

In the parallax barrier 327 illustrated in FIG. 16, each opening 327a may be formed so as to overlap one first sub pixel SP1 and one second sub pixel SP2 in the column direction in plan view. In this case, the openings 327a are disposed in each of the row direction (first direction D1) and the column direction (second direction D2).

The drive circuit 21 includes, for example, a central processing unit (CPU), a read only memory (ROM), a random access memory (RAM), an internal storage, an input interface, and an output interface. The CPU, the ROM, the RAM, and the internal storage are coupled to each other through an internal bus. The ROM stores a computer program such as BIOS. The internal storage is, for example, a hard disk drive (HDD) or a flash memory and stores operating system programs and application programs. The CPU implements various kinds of functions by executing computer programs stored in the ROM or the internal storage by using the RAM as a work area.

It should be understood that the present disclosure provides any other effects achieved by aspects described above in the present embodiment, such as effects that are clear from the description of the present specification or effects that could be thought of by the skilled person in the art as appropriate.

What is claimed is:

1. A head-up display comprising:
a liquid crystal display device configured to emit first light corresponding to a first image from a display surface toward a light-transmitting body in a first emission direction and to emit second light corresponding to a second image from the display surface in a second emission direction different from the first emission direction; and
a reflective plate having a reflection surface on which the second light is incident and that reflects the second light toward the light-transmitting body in the first emission direction.

2. The head-up display according to claim 1, wherein
a first angle between a direction orthogonal to the display surface and the first emission direction is equal to a second angle between the orthogonal direction and the second emission direction, and
the display surface is orthogonal to the reflection surface.

3. The head-up display according to claim 1, wherein
the liquid crystal display device includes
a display panel including a plurality of pixels disposed in a matrix of rows and columns in plan view, and
a light source device configured to emit light toward the display panel,
the pixels include first pixels corresponding to the first image and second pixels corresponding to the second image,
each of the first pixels includes a plurality of first sub pixels,
each of the second pixels includes a plurality of second sub pixels, and
the display panel further includes a parallax barrier configured to
pass light traveling in the first emission direction among light emitted from the light source device and transmitted through the first sub pixels, and pass light traveling in the second emission direction among light emitted from the light source device and transmitted through the second sub pixels, and
block light traveling in the second emission direction among light emitted from the light source device and transmitted through the first sub pixels and light traveling in the first emission direction among light emitted from the light source device and transmitted through the second sub pixels.

4. A head-up display comprising:
a liquid crystal display device configured to emit first light corresponding to a first image from a display surface toward a light-transmitting body in a first emission direction and to emit second light corresponding to a second image from the display surface in a second emission direction different from the first emission direction;
a 1/4 wave plate on which the second light emitted from the display surface is incident; and
a reflective plate having a reflection surface that reflects light transmitted through the 1/4 wave plate, in the second emission direction toward the display surface through the 1/4 wave plate, wherein
a first angle between a direction orthogonal to the display surface and the first emission direction is equal to a second angle between the orthogonal direction and the second emission direction, and
the liquid crystal display device includes a reflective polarizing plate configured to pass linearly polarized light having a first polarization direction and to reflect linearly polarized light having a second polarization direction orthogonal to the first polarization direction.
